(19) United States
(12) Patent Application Publication
(10) Pub. No.: US 2021/0100232 A1
(43) Pub. Date: Apr. 8, 2021

(54) SPRING LOADED FISHING POLE ASSEMBLY

(71) Applicant: Stephen Brandon, Lakewood, CO (US)

(72) Inventor: Stephen Brandon, Lakewood, CO (US)

(21) Appl. No.: 16/592,100

(22) Filed: Oct. 3, 2019

(51) Int. Cl. A01K 87/02; A01K 89/015

(52) U.S. Cl. CPC A01K 87/02; A01K 89/01925

(57) ABSTRACT

A spring loaded fishing pole assembly for increasing the casting distance of a fishing lure includes a handle that has a first socket therein. An extension rod releasably engaging the first socket and the extension rod has a second socket therein. A fishing pole is provided that has a plurality of coils formed therein to define a coiled section of the fishing pole. The fishing pole releasably engages the second socket. Moreover, the fishing pole is comprised of a resiliently bendable material thereby facilitating the coiled section to whip the fishing pole when the fishing pole is cast. In this way the fishing pole increases a casting distance of a lure.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fishing pole device and more particularly pertains to a new fishing pole device for increasing the casting distance of a fishing lure.

### (2) Description of Related Art Including Information Disclosed Under 37 CFR 1.97 and 1.98

The prior art relates to fishing pole devices.

### BRIEF SUMMARY OF THE INVENTION

An embodiment of the disclosure meets the needs presented above by generally comprising a handle that has a first socket therein. An extension rod releasably engaging the first socket and the extension rod has a second socket therein. A fishing pole is provided that has a plurality of coils formed therein to define a coiled section of the fishing pole. The fishing pole releasably engages the second socket. Moreover, the fishing pole is comprised of a resiliently bendable material thereby facilitating the coiled section to whip the fishing pole when the fishing pole is cast. In this way the fishing pole increases a casting distance of a lure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a spring loaded fishing pole assembly according to an embodiment of the disclosure.

FIG. 2 is a right side view of an embodiment of the disclosure.

FIG. 3 is a back view of an embodiment of the disclosure.

FIG. 4 is a top view of an embodiment of the disclosure.

FIG. 5 is a cross sectional view taken along line 5-5 of FIG. 4 of an embodiment of the disclosure.

FIG. 6 is a perspective view of a case of an embodiment of the disclosure.

### DETAILED DESCRIPTION OF THE INVENTION

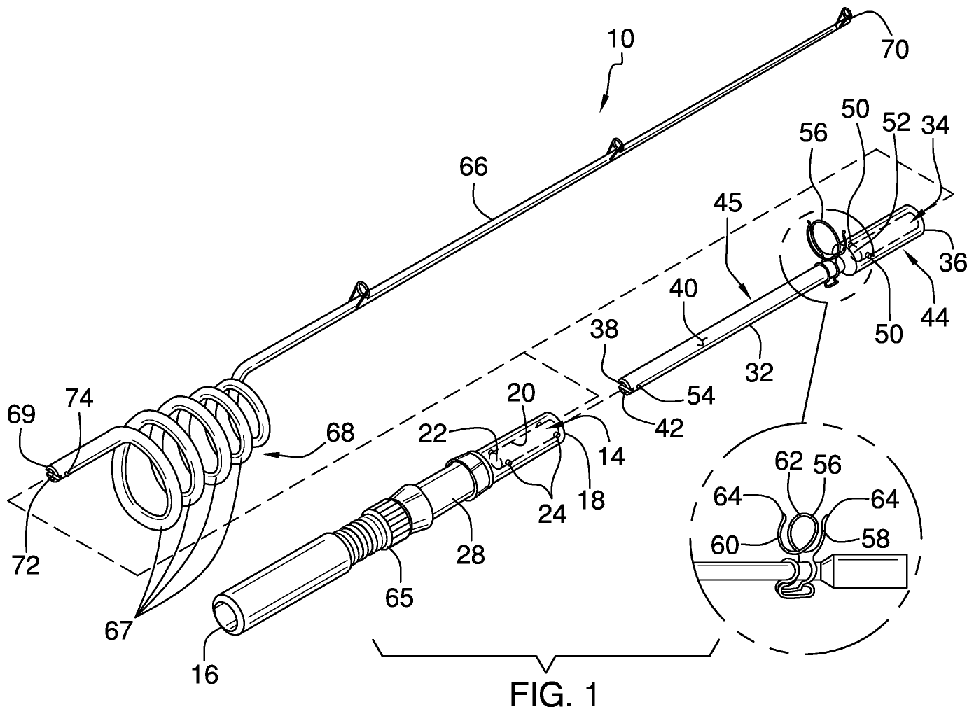

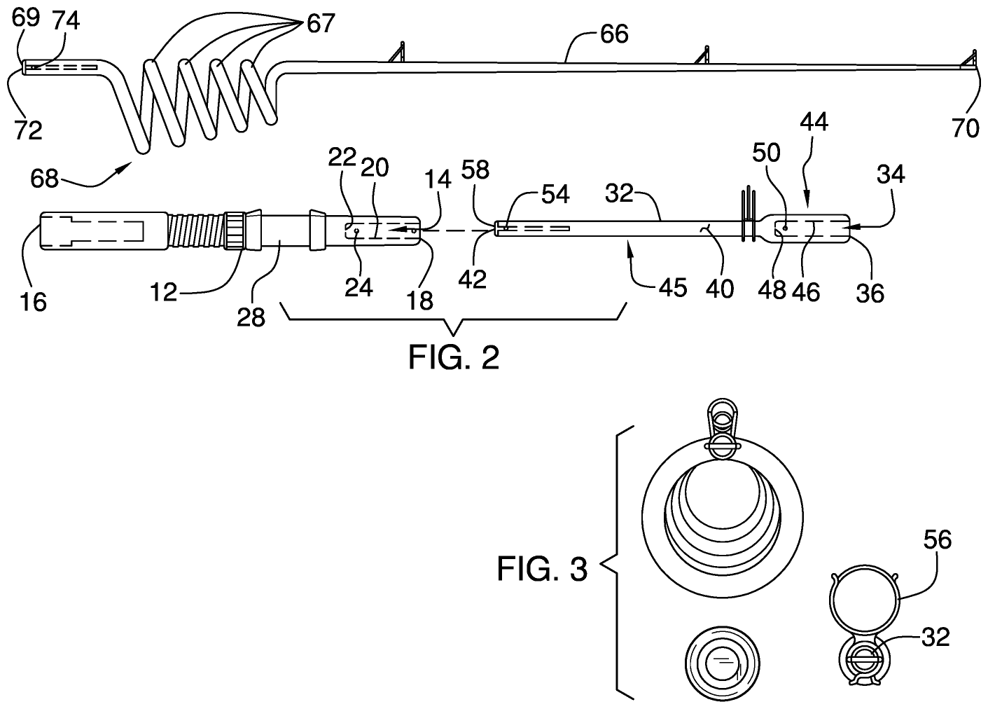

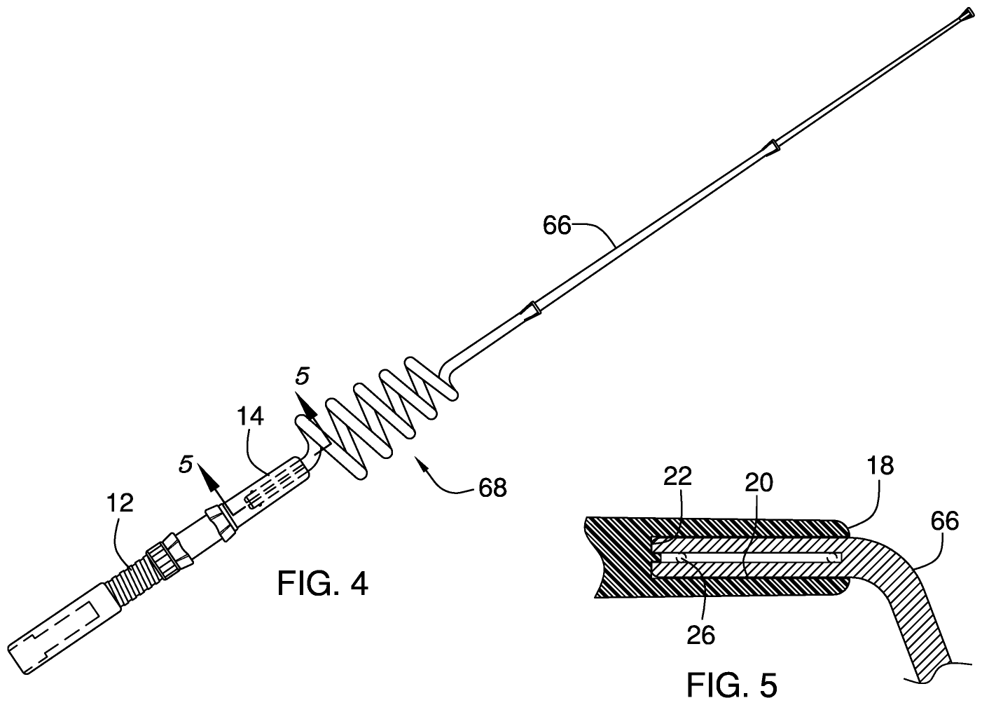

With reference now to the drawings, and in particular to FIGS. 1 through 6 thereof, a new fishing pole device embodying the principles and concepts of an embodiment of the disclosure and generally designated by the reference numeral 10 will be described.

As best illustrated in FIGS. 1 through 6, the spring loaded fishing pole assembly 10 generally comprises a handle 12 that has a first socket 14 therein. The handle 12 has a first end 16 and a second end 18, and the handle 12 is elongated between the first 16 and second 18 ends. The first socket 14 extends into the second end 18 toward the first end 16, and the first socket 14 has an outward bounding surface 20 and a lower bounding surface 22. The outward bounding surface 20 has a plurality of engagements 24 being recessed therein and the lower bounding surface 22 has a ridge 26 extending upwardly therefrom. The handle 12 has a fishing reel receiver 28 thereon for releasably retaining a fishing reel 30 on the handle 12.

An extension rod 32 is provided that releasably engages the first socket 14 and the extension rod 32 has a second socket 34 therein. The extension rod 32 has a primary end 36, a secondary end 38 and an outer surface 40 extending therebetween. The primary end 36 has a slot 42 extending toward the secondary end 38. The slot 42 engages the ridge 26 on the lower bounding surface 22 of the first socket 14 when the primary end 36 is inserted into the first socket 14 such that the extension rod 32 is inhibited from rotating in the first socket 14. The outer surface 40 flares outwardly proximate the secondary end 38 to define a first portion 44 of the extension rod 32 that has a diameter being greater than a second portion 45 of the extension rod 32.

The second socket 34 extends into the secondary end 38 toward the first end 16. The second socket 34 has an outward bounding surface 46 and a lower bounding surface 48. The outward bounding surface 46 of the second socket 34 has a plurality of engagements 50 being recessed therein. Additionally, the lower bounding surface 48 of the second socket 34 has a ridge 52 extending upwardly therefrom. A plurality of first tabs 54 is each coupled to the outer surface 40 of the extension rod 32. Each of the first tabs 54 is positioned adjacent to the primary end 36. Each of the first tabs 54 releasably engages a respective one of the engagements 24 in the outward bounding surface 20 of the first socket 14 when the extension rod 32 is inserted into the first socket 14.

An eyelet 56 is coupled around the extension rod 32. The eyelet 56 has a first finger 58 curving upwardly from the extension rod 32. Additionally, the eyelet 56 has a second finger 60 that is curved to form a coil 62 extending rearwardly from the first finger 58. Each of the first 58 and second 60 fingers has a distal end 64 and the distal end 64 of each of the first 58 and second 60 fingers is positioned on opposite sides of the eyelet 56 from each other. In this way a fishing line can be positioned between the first 58 and second 60 fingers thereby facilitating the fishing line to be extended through the coil 62 without threading an end of the fishing line through the eyelet 56. The eyelet 56 is positioned on the second portion 45 of the extension rod 32 adjacent to the first portion 44 of the extension rod 32.

A fishing pole 66 is provided that has a plurality of coils 67 formed therein to define a coiled section 68 of the fishing pole 66. The fishing pole 66 is comprised of a resiliently bendable material thereby facilitating the coiled section 68 to whip the fishing pole 66 when the fishing pole 66 is cast. In this way the fishing pole 66 increases a casting distance of a lure. The fishing pole 66 has a first end 69 and a second end 70, and the coiled section 68 is positioned adjacent to the first end 69 of the fishing pole 66. The plurality of coils 67 decrease in diameter between the first 68 and second 70 ends of the fishing pole 66. The first end 69 of the fishing pole 66 has a slot 72 extending toward the second end 70. The slot 72 in the first end 69 of the fishing pole 66 engages the ridge 52 on the lower bounding surface 48 of the second socket 34 when the first end 69 of the fishing pole 66 is inserted into the second socket 34.

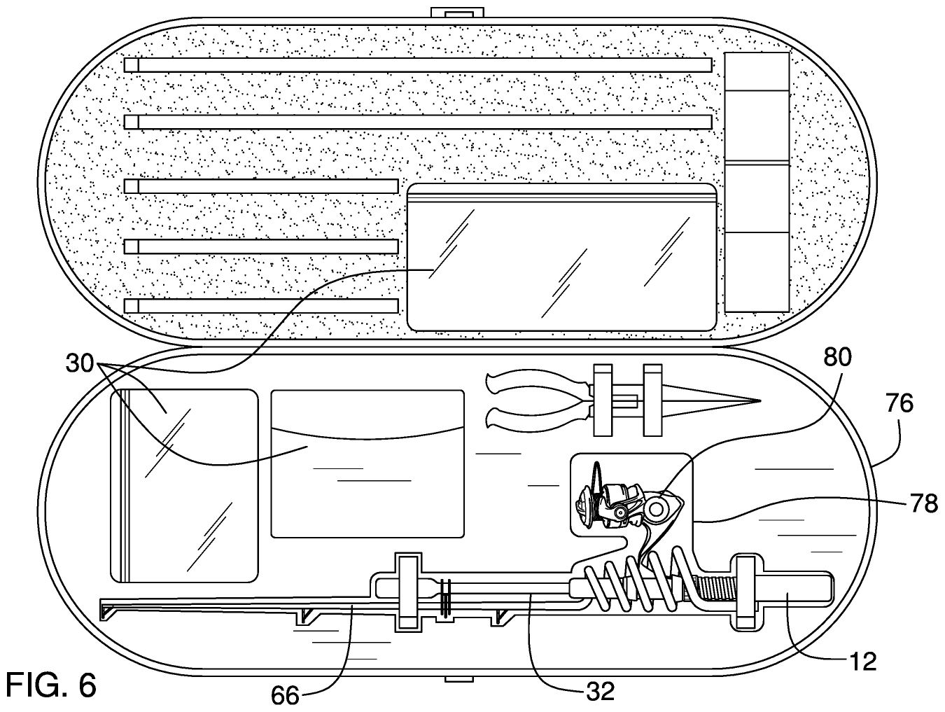

A plurality of second tabs 74 is each coupled to an outer surface of the fishing pole 66. The second tabs 74 on the fishing pole 66 are positioned adjacent to the first end 16 of the fishing pole 66. Each of the second tabs 74 releasably engages a respective one of the engagements 50 in the outward bounding surface 46 of the second socket 34 when the fishing pole 66 is inserted into the second socket 34. As is most clearly shown in FIG. 6, a case 76 may be provided that has a storage recess 78 therein for storing the handle 12, the extension rod 32 and the fishing pole 66. The extension rod 32 is attached to the handle 12, and each of the extension rod 32 and the handle 12 are extended through the coiled section 68 of the fishing pole 66 for storage in the storage recess 78. Additionally, the case 76 may include a plurality of storage areas 80 for storing fishing tackle and fishing accessories.

In use, the extension rod 32 is inserted into the first socket 14 in the handle 12 and the fishing pole 66 is inserted into the second socket 34 in the extension rod 32. The coiled section 68 of the fishing pole 66 facilitates the fishing pole 66 to be whipped when casting. In this way the fishing pole 66 increases the casting distance of the lure when the lure is cast. The fishing pole 66 can be inserted into the first socket 14 in the handle 12 in lieu of the extension rod 32 to lessen the overall length of the handle 12 and the fishing pole 66. In this way the fishing pole 66 can be more easily cast by a child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A spring loaded fishing pole assembly being configured to assist with casting a lure, said assembly comprising:
a handle having a first socket therein;
an extension rod releasably engaging said first socket, said extension rod having a second socket therein; and
a fishing pole having a plurality of coils being formed therein to define a coiled section of said fishing pole, said fishing pole releasably engaging said second socket, said fishing pole being comprised of a resiliently bendable material thereby facilitating said coiled section to whip said fishing pole when said fishing pole is cast wherein said fishing pole is configured to increase a casting distance of a lure.

2. The assembly according to claim 1, wherein said handle has a first end and a second end, said handle being elongated between said first and second ends, said first socket extending into said second end toward said first end, said first socket having an outward bounding surface and a lower bounding surface, said outward bounding surface having a plurality of engagements being recessed therein, said lower bounding surface having a ridge extending upwardly therefrom, said handle having a fishing reel receiver thereon for releasably retaining a fishing reel on said handle.

3. The assembly according to claim 2, wherein said extension rod has a primary end, a secondary end and an outer surface extending therebetween, said primary end having a slot extending toward said secondary end, said slot engaging said ridge on said lower bounding surface of said first socket when said primary end is inserted into said first socket such that said extension rod is inhibited from rotating in said first socket.

4. The assembly according to claim 3, wherein said outer surface flares outwardly proximate said secondary end to define a first portion of said extension rod having a diameter being greater than a second portion of said extension rod, said second socket extending into said secondary end toward said first end, said second socket having an outward bounding surface and a lower bounding surface, said outward bounding surface of said second socket having a plurality of engagements being recessed therein, said lower bounding surface of said second socket having a ridge extending upwardly therefrom.

5. The assembly according to claim 4, further comprising a plurality of first tabs, each of said first tabs being coupled to said outer surface of said extension rod, each of said first tabs being positioned adjacent to said primary end, each of said first tabs releasably engaging a respective one of said engagements in said outward bounding surface of said first socket when said extension rod is inserted into said first socket.

6. The assembly according to claim 4, further comprising an eyelet being coupled around said extension rod, said eyelet having a first finger curving upwardly from said extension rod, said eyelet having a second finger being curved to form a coil extending rearwardly from said first finger, each of said first and second fingers having a distal end, said distal end of each of said first and second fingers being positioned on opposite sides of said eyelet from each other wherein said first and second fingers are configured to facilitate a fishing line to be positioned between said first and second fingers, said eyelet being positioned on said second portion of said extension rod adjacent to said first portion of said extension rod.

7. The assembly according to claim 4, wherein said fishing pole has a first end and a second end, said coiled section being positioned adjacent to said first end of said fishing pole, said plurality of coils decreasing in diameter between said first and second ends, said first end of said fishing pole having a slot extending toward said second end, said slot in said first end of said fishing pole engaging said ridge on said lower bounding surface of said second socket when said first end of said fishing pole is inserted into said second socket.

8. The assembly according to claim 7, further comprising a plurality of tabs each being coupled to an outer surface of said fishing pole, said tabs on said fishing pole being positioned adjacent to said first end of said fishing pole, each of said tabs releasably engaging a respective one of said engagements in said outward bounding surface of said second socket when said fishing pole is inserted into said second socket.

9. A spring loaded fishing pole assembly being configured to assist with casting a lure, said assembly comprising:
a handle having a first socket therein, said handle having a first end and a second end, said handle being elongated between said first and second ends, said first socket extending into said second end toward said first end, said first socket having an outward bounding surface and a lower bounding surface, said outward bounding surface having a plurality of engagements being recessed therein, said lower bounding surface having a ridge extending upwardly therefrom, said handle having a fishing reel receiver thereon for releasably retaining a fishing reel on said handle;
an extension rod releasably engaging said first socket, said extension rod having a second socket therein, said extension rod having a primary end, a secondary end and an outer surface extending therebetween, said primary end having a slot extending toward said secondary end, said slot engaging said ridge on said lower bounding surface of said first socket when said primary end is inserted into said first socket such that said extension rod is inhibited from rotating in said first socket, said outer surface flaring outwardly proximate said secondary end to define a first portion of said extension rod having a diameter being greater than a second portion of said extension rod, said second socket extending into said secondary end toward said first end, said second socket having an outward bounding surface and a lower bounding surface, said outward bounding surface of said second socket having a plurality of engagements being recessed therein, said lower bounding surface of said second socket having a ridge extending upwardly therefrom;
a plurality of first tabs, each of said first tabs being coupled to said outer surface of said extension rod, each of said first tabs being positioned adjacent to said primary end, each of said first tabs releasably engaging a respective one of said engagements in said outward bounding surface of said first socket when said extension rod is inserted into said first socket;
an eyelet being coupled around said extension rod, said eyelet having a first finger curving upwardly from said extension rod, said eyelet having a second finger being curved to form a coil extending rearwardly from said first finger, each of said first and second fingers having a distal end, said distal end of each of said first and second fingers being positioned on opposite sides of said eyelet from each other wherein said first and second fingers are configured to facilitate a fishing line to be positioned between said first and second fingers, said eyelet being positioned on said second portion of said extension rod adjacent to said first portion of said extension rod; and
a fishing pole having a plurality of coils being formed therein to define a coiled section of said fishing pole, said fishing pole being comprised of a resiliently bendable material thereby facilitating said coiled section to whip said fishing pole when said fishing pole is cast wherein said fishing pole is configured to increase a casting distance of a lure, said fishing pole having a first end and a second end, said coiled section being positioned adjacent to said first end of said fishing pole, said plurality of coils decreasing in diameter between said first and second ends, said first end of said fishing pole having a slot extending toward said second end, said slot in said first end of said fishing pole engaging said ridge on said lower bounding surface of said second socket when said first end of said fishing pole is inserted into said second socket; and
a plurality of tabs each being coupled to an outer surface of said fishing pole, said tabs on said fishing pole being positioned adjacent to said first end of said fishing pole, each of said tabs releasably engaging a respective one of said engagements in said outward bounding surface of said second socket when said fishing pole is inserted into said second socket.
